(19) United States
(12) Patent Application Publication
(10) Pub. No.: US 2018/0189893 A1
(43) Pub. Date: Jul. 5, 2018

(54) OBJECT MANAGEMENT SYSTEM

(71) Applicant: COLLABITAL PTY LTD, Double Bay ,New South Wales (AU)

(72) Inventor: Benjamin Nissim ELIAS, Double Bay, New South Wales (AU)

(21) Appl. No.: 15/738,332

(22) PCT Filed: Jun. 23, 2016
(86) PCT No.: PCT/AU2016/050535

§ 371 Date: Dec. 20, 2017

(30) Foreign Application Priority Data
Jun. 23, 2015 (AU) 2015902425

(51) Int. Cl. G06Q 50/00; H04L 29/06; G06Q 20/06; G07C 13/00

(52) U.S. Cl. CPC G06Q 50/01; H04L 63/08; G07C 13/00; G06Q 20/065; H04L 63/102

(57) ABSTRACT

A system for managing objects, the system performing the steps of: at a first application: receiving user input identifying a user request to access the first application, the application facilitating creation of competition objects and notification of the competition objects to a social network; Retrieving a user identification for the user; The first application automatically generating a request for user access rights to the social network and transmitting the request to a social network platform for the social network using the user identification; receiving from the network gateway social network user access rights associated with the user, the user access rights comprising permissions granted to the user within the social network; receiving user input requesting creation of a competition object; creating a competition object in response to the user request; receiving user input requesting the competition object to be notified to a target population of subscribers within the social network; the application using the received social network user access rights to determine a subset of the target population to be notified; and; requesting the social network platform to notify the determined subset of subscribers of the competition object.

The present invention relates to an object management system.

### BACKGROUND

Social network applications, for example the business network application Yammer and the personal network application Facebook, have created online digital communities joining groups of individuals with common interests. Corporate entities establish digital business networks for employees with sub groups for teams and divisions. Digital personal networks include the ability to create sub groups for clubs and societies. Social network applications provide a medium for messaging, notifications and exchange of information.

Social network applications are increasing popular with subscribers checking their accounts regularly. Such social network applications provide an effective forum for subscribers with similar interests to share views and opinions and ideas.

### SUMMARY OF THE INVENTION

In a first aspect the invention provides a system for managing objects, the system performing the steps of: at a first application:
receiving user input identifying a user request to access the first application, the application facilitating creation of competition objects and notification of the competition objects to a social network;
retrieving a user identification for the user;

The first application automatically generating a request for user access rights to the social network and transmitting the request to a social network platform for the social network using the user identification;
receiving from the network gateway social network user access rights associated with the user, the user access rights comprising permissions granted to the user within the social network;
receiving user input requesting creation of a competition object;
creating a competition object in response to the user request;
receiving user input requesting the competition object to be notified to a target population of subscribers within the social network;
the application using the received social network user access rights to determine a subset of the target population to be notified; and;
requesting the social network platform to notify the determined subset of subscribers of the competition object.

An embodiment comprises the further steps of:
receiving a user request to create a competition object within the first application;
retrieving first application user access rights, the first application user access rights comprising permissions granted to the user within the first application; wherein the step of facilitating creation of the competition object is performed in accordance with the first application user access rights.

An embodiment provides the steps of:
requesting user identification information from the user on receiving the user request to access the first application; and
receiving user identification information;
wherein the step of requesting user access to the network is performed in dependence on the user identification information being authorised by the first application.

In an embodiment creation of a competition object comprises creating a competition.

In an embodiment creation of a competition object comprises creating an entry to a competition.

In an embodiment permissions include at least one of:
permission to create a competition;
permission to edit a competition;
permission to create an entry to a competition;
permission to allocate voting chips for a competition;
list of subscribers which the user is permitted to notify.

In a second aspect the invention provides a system for notifying subscribers of a competition object comprising the steps of:
storing the competition object:
associating entries to the competition to the competition object.

An embodiment provides steps of allocating virtual currency to a subscriber, the currency for supporting entries to the competition.

An embodiment provides steps of a subscriber assessing entries according to a rating scale.

In an embodiment the network is a social network application.

In a third aspect the invention provides a system for managing content objects, the system performing the steps of:
receiving a user request to access a first application, the application facilitating creation of content objects and notification of the content objects to subscribers within a network;
requesting user access to the network from a network gateway;
receiving from the network gateway user access rights, the user access rights comprising permissions granted to the user within the network;
facilitating creation of a content object by the user;
receiving a user notification request, the user notification request requesting the content object to be notified to network subscribers; and
requesting the network to notify the network subscribers of the content object in accordance with the user access rights to the network.

An embodiment comprises the further steps of:
receiving a user request to create a content object within the first application;
retrieving first application user access rights, the first application user access rights comprising permissions granted to the user within the first application; wherein the step of facilitating creation of the content object is performed in accordance with the first application user access rights.

An embodiment comprises the steps of:
requesting user identification information from the user on receiving the user request to access the first application; and
receiving user identification information;
wherein the step of requesting user access to the network is performed in dependence on the user identification information being authorised by the first application.

In a fourth aspect the invention provides a method for managing content objects, the method performing the steps of:
receiving a user request to access a first application, the application facilitating creation of content objects and notification of the content objects to subscribers within a network;
requesting user access to the network from a network gateway;
receiving from the network gateway user access rights, the user access rights comprising permissions granted to the user within the network;
facilitating creation of a content object by the user;
receiving a user notification request, the user notification request requesting the content object to be notified to network subscribers; and
requesting the network to notify the network subscribers of the content object in accordance with the user access rights to the network.

In a fifth aspect the invention provides a system for managing content objects, comprising:
login engine for receiving a user request to access a first application, the application facilitating creation of content objects and notification of the content objects to subscribers within a network;
means for requesting user access to the network from a network gateway;
means for receiving from the network gateway user access rights, the user access rights comprising permissions granted to the user within the network;
facilitating creation of a content object by the user;
input device for receiving a user notification request, the user notification request requesting the content object to be notified to network subscribers; and
means for requesting the network to notify the network subscribers of the content object in accordance with the user access rights to the network.

In an embodiment the content object is a user generated content object.

In an embodiment the content object is a competition object or a competition entry object.

### FIGURES

FIG. 1 shows signalling between components in an embodiment;

FIGS. 2a and 2 b illustrate objects in an embodiment;

FIG. 3 is a flow chart illustrating the steps taken by the platform application;

FIG. 4 illustrates arrangement of components in an embodiment.

FIG. 5 illustrates a hierarchy of objects.

### DESCRIPTION

### Overview of Components of System (Platform, Social Network and Groups)

Embodiments of the invention relate to a platform application for facilitating the creation of digital objects and the interaction of a group of users with those digital objects. The platform application allows a user to create an object. In an example the object is a competition. The platform application allows the user to select a distribution group for the object and invite the members of the distribution group to interact with the object. For example, the user may select that the competition be shared with a group from their workplace. The members of the group are invited to create an entry to the competition within the platform. Competition entries can also be shared within the group. In some embodiments, members of the group are invited to support the competition entries, for example by voting. In some embodiments, competition entries may also be shared with members of other groups or other members outside the primary group.

The platform application is linked to a communication network having subscribers, for example a social network application. Typically, subscribers to the platform application are also subscribers to the social network application. The social network application allows subscribers to create or join network user groups. For example a company may create a master group including all employees. Within the master group, subgroups may be created for different business units. Further subgroups may be created for teams within the business units. Further subgroups may be created for cross functional groups. In a social network application, subscribers may create or join groups of friends or groups associated with clubs or organisations or other groups with common interests. The groups may be open access, in which subscribers can join the group with no authorisation required, or closed access in which subscriber lists to the group are closed. Subscribers may be members of multiple groups.

The group structure within the network application allows users to create and share content within their network groups. For example, a company group may create a company page within the communication network which member of the group can share comments or suggestions.

Users are provided with permissions within the network application. Permissions can be configured to control a user's rights to create an object within the network application, edit an object within the network application, interact with an object in the network application. Permissions can also be configured to control the users to which a user can share objects, for example permissions may confine communications of a user to those groups to which the user is a member.

Permissions can be controlled on a group basis, for example a user may be granted a set of permissions within a first group and a second set of permissions within a second group. Permissions may also be granted on an individual basis, for example a user is provided with a set of permissions which apply across the entire application for any group for which that user is a member. Permissions for a particular user may be a combination of user specific permissions and group specific permissions, for example a user may be provided with object admin permissions up to a first permissions level and can then be granted permissions up to that level in any group in which they are a member.

Users can also be provided with permissions within the platform application. The permissions required for the platform application may or may not have a relevant, comparable permission in the social network application. If a relevant, comparable social network application permission exists, it can always be made more granular or overridden by the platform application, as is detailed in Table 1.

The permissions of the social network application are designed for its own purposes and not necessarily with any the platform application in mind. For example, the social network application might have a permission of “belonging to group X”—the platform application takes that permission and applies that in context for its own purpose.

Interaction of Platform with Social Network

In an embodiment a user requests access to the platform application, the platform application facilitating creation of competition objects and notification about changes made to competition objects to users within a social network application. The user may have to login to the platform application using security identification. Examples of security identification include username, account number, password, code, token. Other security information may be required.

On behalf of a user, the platform application requests access to the social network application. The user may be required to login to the social network application using security identification. The platform application is then able to request the access rights of the user, those access rights comprising permissions granted to the user within the social network application. Typically, the platform application is provided with the user's access rights on the condition of the user successfully logging into the social network application.

The platform application facilitates creation of a competition object by the user. The competition object may be a new competition or may be an entry to an existing competition or may be another object related to a competition. The user provides a user notification request, the user notification request requesting the competition object or other object to be notified to social network users. The request may relate to a social network group or groups to which the user is a member.

On behalf of the user, the platform application requests the social network application to notify a set of users in accordance with the user's access rights to the social network application. The platform application limits its request to the conditions allowed by the social network application.

In the social network application's application programming interface (API), there is typically a way of an application creating a message or activity item. In the case of Yammer, a message can be created in the relevant group. The platform application is generally granted the same permissions as the user is allowed. So if the platform application posts a message to the social network application group, that will only be accepted by the social network application if the user has that permission within the social network application.

To aid the user experience, preferably, the platform application checks that the requested action is likely to be accepted by the social network application (i.e. only post to groups the user is permitted to post to). This check is made immediately before the notification is sent to the social network application.

As described above, typically, the platform application identifies the user access rights for the user within the social network application. The platform application creates a notification for subscribers of the social network that will be notified of the competition object. The platform application then transmits the notification to the social network application along with a distribution list of social network subscribers who should be notified using the user permissions of the social network application.

In an embodiment the platform application includes user access rights associated with the user. These access rights define the permissions the user holds within the platform application. These permissions may overlap with the social network application permissions. In further embodiments the permissions are determined independently of the social network application permissions. On receiving a user request to create a competition object within the platform application the platform application retrieves platform application user permissions specific to objects contained within the platform application. The platform application allows creation of the competition object in accordance with a combination of the user's platform application permissions and social network application permissions. The permissions may vary depending on the object that the user is requesting to create, for example a competition or an entry to an existing competition.

In an embodiment a user of the platform application is required to log into the platform application and the social network application.

In embodiments, permissions include at least one of permission to create a competition;
permission to edit a competition, permission to create an entry to a competition, permission to allocate voting chips for a competition, permission to assess entries according to a rating scale. Permissions may include a list of users which the user is permitted to notify. Permissions may include a list of social network groups or groups to which the user is a member.

In embodiments the platform application includes a database for storing competition objects. Any edits or entries to the competition are associated with the competition.

### Login Protocol

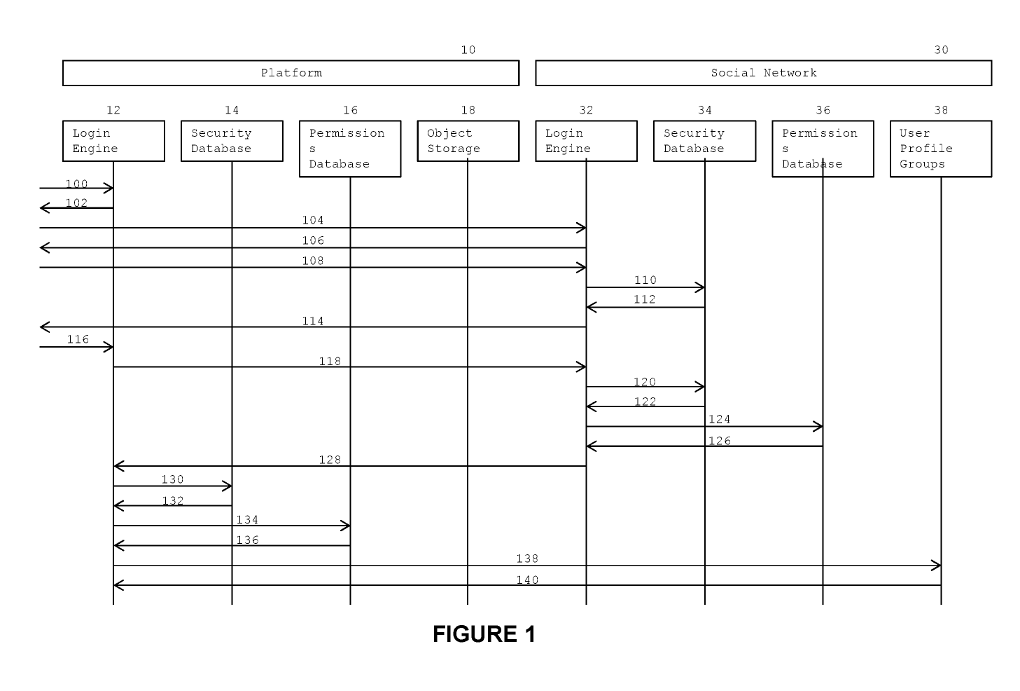

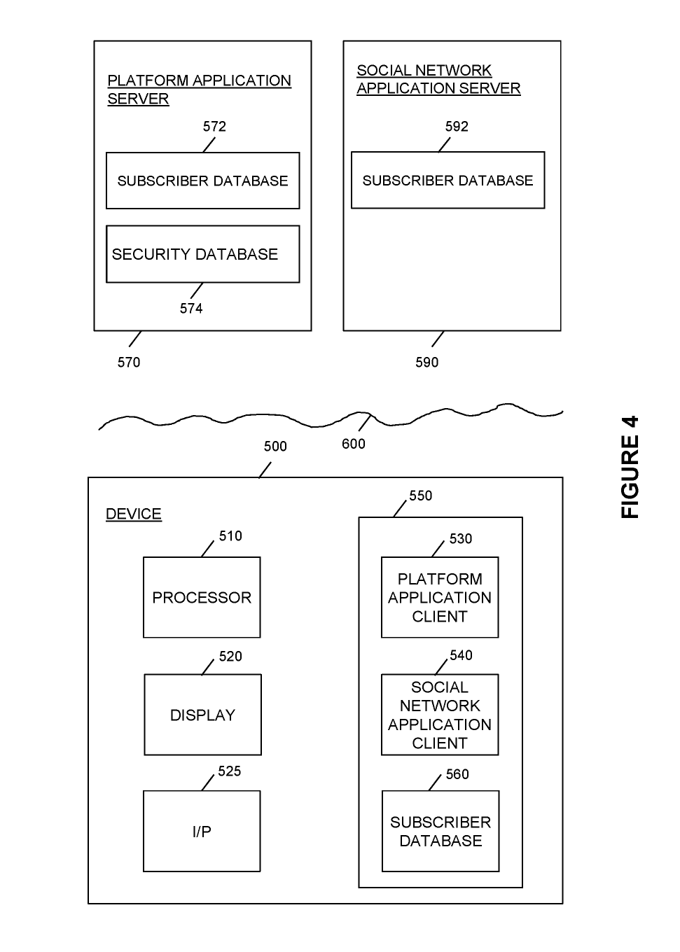

FIG. 1 shows the chain of communications and authorisations in a first embodiment of the invention. FIG. 4 shows the physical position of components within an embodiment. The system of FIG. 1 is managed across two environments, a platform application environment 10 and a network application environment 30. The platform is an application for creating and interacting with competition content. The platform application client 530 is loaded onto a device 500. The device may be a PC, laptop, mobile phone, tablet or other device with a network connection. In certain embodiments the device may hold certain platform application data locally, including user authorisation data and competition object data. Such data is stored in a subscriber database 560 area within the memory 550 of device 500.

The platform application client 530 is configured to connect with platform application server 570. The platform application server 570 is contacted across a communications network 600. The platform application server 570 is a central storage and processing server holding user information for all users of the platform application along with user authorisation information. Device 570 may also hold object data and a database of all user permissions for objects associated with the platform application.

The platform application client is configured to operate with a social network application. A social network application client 540 is loaded onto device 500. The network application is a communications network. The platform application client 530 is provided with contact information for a social network application server 590. The social network application server 590 is a central storage and processing server holding user information, user authorisation information, object data and holds a database of permissions associated with all subscribers to the social network application. The permissions represent those permissions of the user within the social network application.

The platform application server 570 is provided with contact information for the same social network application server 590 as device 530.

In order to gain full functionality of the platform application, the user is required to be a subscriber to the platform application and also to the social network application.

At 100 a user requests the platform application landing page from the platform login engine 12 At 102 the user receives the platform application landing page from the platform login engine 12. The response 102 includes the address of the network login engine 32 and a code specific to the platform application (Platform Application Code) (used later in step 114).

At 104 the user is directed to make a request of the social network login engine, passing the Platform Application Code received in 102. In the event that the user is already logged in to the social network application then the system proceeds to step 114. If the user is not logged in to the social network application, social network login engine requests security identification from User at 106. The user provides security identification to the social network login engine at 108. The social network login engine verifies the user login information with its security database 34 592 at 110. The security database 34 592 confirms whether the user is authorised at 112. If the user is authorised the social network login engine 3 returns a code (Temporary Code) to the user and the address of the platform login engine which is associated with the Platform Application Code at 114.

At 116 the user provides the temporary code to the platform application login engine. At 118 platform login engine requests the ability to access the social network application 30 on behalf of the user by providing the Temporary Code and Platform Application Secret to the social network login engine 32. Further information may be required by the social network login engine for the request 118 to be valid. At 120 the social network login engine verifies the platform application request with its security database 34. At 122 the security database identifies the platform request as authorised to the social network login engine.

After authorisation at 122 the social network login engine requests the permissions of the relevant user from its permissions database 36. The permissions database responds with the permissions of the relevant user.

The permissions of 36 are stored within the social network application. These permissions might include “creating a new group”, “view a particular group”, or “add users to a particular group”. These are stored by the social network application.

It is relevant that the social network application has a permission that “a particular user can access the particular platform application”. That is the critical step that's being evaluated here by the social network application security database.

At 128 social network login engine returns an authentication object to the platform login engine. That response includes the permissions of the user, and a Session Code to be used in all subsequent requests from the platform application to the social network application. The Session Code identifies the requests from the platform application as being on behalf of the user e.g. 136.

The user is logged into the platform application. At 130 the platform application login engine verifies the user with its security database 14.

A new user (as identified by a unique identifier in the social network application authentication object above) creates a new entry in the platform security database. However to avoid duplicates, before creating a new user the security database is checked to see if there is an existing user with that identity—in which case the user with that identity is used.

The platform application security database 14 identifies the user as authorised to the platform application login engine 12. At 134 platform application login engine 12 requests the permissions for the relevant user from its permissions database 16. Permissions database 16 responds at 136 with the permissions for the user. At 138 platform application login engine requests the user profile and group memberships from the social network user profile/groups database 38. The user profile and group memberships are provided to the platform application login engine at 140.

The signalling exchange above follows typical OAuth2 protocol. Other exchange protocols may be implemented. Other protocols could be used including “SAML 2.0”, or “password-based authentication”.

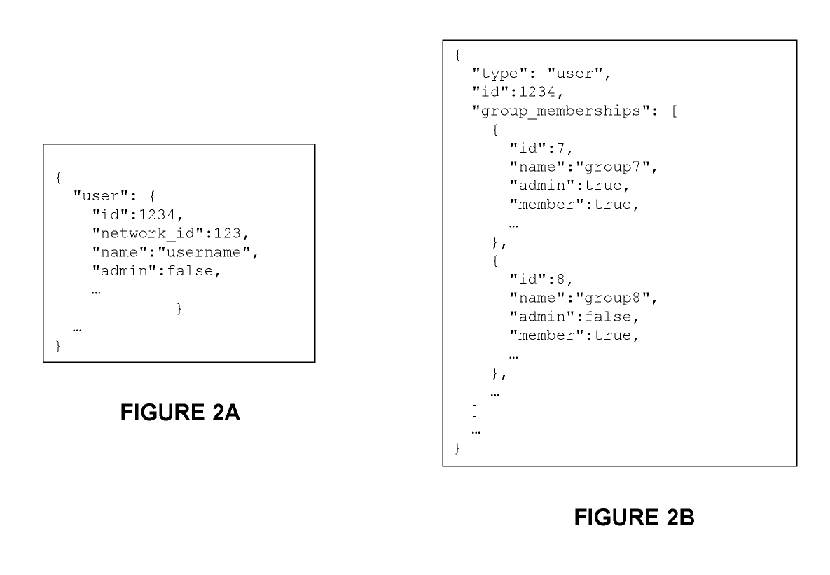

FIGS. 2a and 2b provide examples of user objects which may be provided to the platform application at 128 and 140. FIG. 2a includes basic user profile information. In FIG. 2a, the user has user ID 1234, this identifies the user within the social network application. The user is registered as a member of network ID 123. The username of the user within the social network application is also provided along with confirmation of whether the user has admin rights within network 123.

The user object shown in FIG. 2b identifies all groups of which user 1234 is a member. In the example of FIG. 2b the user is a member of group 7 (having id 7) and group 8 (having id 8). The object also confirms the admin rights of the user within those groups. For group 7 the user has admin rights. For group 8 the user does not have admin rights.

The embodiment described with reference to FIGS. 2a and 2b is not limiting to the invention. In further embodiments further information may be provided including email address, URL, photo etc.

The user permissions and profile are stored within the platform application database along with the user ID. These data may be stored in memory, in the database temporarily during the session or may be stored for a prolonged period.

Some of the fields provided to the platform application within the user object are considered “permissions” by the social network application, for example the user admin status.

Other fields provided to the platform application, such as group memberships, may not be considered “permissions” by the social network application. In some social network applications, it can be possible to create a new social network group as a regular user, without administrator rights or any other special privileges. As creator of the new social network group, the user will have administrator rights to the new social network group. There has been no specific approval to create that social network group, even though the user is able to place restrictions on other subscribers for that social network group, for example denying other subscribers administrative rights for that social network group.

In some social networks, social network groups can be set to “open” or “closed”. In the case of an open social network group, membership does not convey any permission information since any user can join the group without requiring approval. In the case of a closed social network group, membership conveys the fact that an administrator has approved the user joining.

### Permissions

The platform application provides permissions to the user within the platform application. Some platform applications use a combination of “permission” and “non-permission” information to implement the access control regime. In some embodiments “non-permission” information includes information from the social network which may not be used by the social network as the basis for its permissions regime. However “non-permission” information can be used by the platform application for this purpose and may include membership of open social network groups, the number of followers for a user or another test of the user's connectivity within the social network application.

The platform application is generally not able to modify social network application permissions, so the platform application must treat these as read-only permissions. For example it is not possible for the platform application to give user 1234 administrator rights to group 8.

The platform application uses a combination of social network application information at 128 and 140 and platform application information at 136 to restrict what objects each user is able to access and modify within the platform application. These permissions are notified to the platform application during the authorisation procedure discussed above.

The permissions include the List, Show, New, Create, Edit, Update, and Delete actions (e.g. Table 2), as they relate to various Competitions and Entries, where:

New: Show the form for creating a new object;
Create: Save a new object (with the form data from New);
Show: Show the details of an existing object;
Edit: Show the edit form of an existing object;
Update: Save the existing object (with the form data from Edit);
List: Show a list of objects;
Delete: Delete an object.

Minimal information is stored about the user for the length of the logged-in session. Typically, just a single ID number. Within the platform application, that number is sufficient to determine the permissions of every action on a per-request basis.

The platform application stores links between user IDs and various objects (e.g. Competitions). [[1,2],[1,3]] means User 1 (the first column) has access to Competitions 1 and 3 (the second column).

Each time the user does something for example, view a Competition, the permissions are checked.

The platform application should only show a user the objects they are able to see, and show actions they are able to perform. For example an “Edit” button only shows up on the “Show” page if the user has “Edit” permissions. The user could try and view the Edit page by requesting the relevant URL (/competitions/1/edit) but that is denied by the platform application when received.

User platform application permissions can be independent of the user social network application permissions. In relation to social network objects, it would be unusual for a platform application to enforce more restrictive permissions than the social network application since the user would be unable to optimise their use of the social network application. However, this is a possibility.

More generally, the platform application may provide users with the same permissions or broader permissions compared with those allocated within the social network application. For example the platform application may allow certain users the ability to modify more platform application objects than the social network application would otherwise allow.

In other circumstances the platform application may seek to further restrict the ability of users to perform certain actions, for example the ability to modify platform application objects that were created by another user.

The platform application may allocate permissions after receiving the social network application permissions for the user or allocate permissions entirely independently. In any case, the platform application stores the user's social network application permissions against the user account.

After the user network application permissions are provided to the platform application they are stored in user account database against the user account. The permissions may be stored locally on the device or at the platform server.

In preferred embodiments the user social network application permissions are stored temporarily by the platform application. This reduces the storage requirements the platform application and also reduces the need for ongoing synchronisation between the platform application and the social network application. The platform application is provided with up-to-date user social network application permissions and can be refreshed to take into account changes to subscriber social network application permissions.

### Example Permissions

As discussed above, certain permissions are provided to a user within the social network application and the platform application. The permissions are granted based on a user's profile.

The broadest permissions granted with a social network application or the platform application are application administrative (admin) permissions. Application admin permission gives the user permission to create, edit and delete objects throughout the entire application (or user's network within the application).

Users form user groups within the social network application. User group admin permissions can be allocated to particular members of the group. User group admin permissions provide administrative permissions on a group level. A user group admin permission is granted to a member of the group. User group admin permission grants the user admin rights for objects within the specific group only. For example a user having user group 8 admin permissions may create, edit and delete objects within group 8 but is provided with no permissions for objects for other groups under this specific permission.

Group members are provided general permissions to interact with other group members and group objects. These permissions include creating notifications to other group members. Group members are also provided permissions to respond to group objects. In the platform application this can be the basis for permissions, for example a group member is permitted to create a competition entry where the competition entry is associated (through a competition) with the relevant group. Consequently the user is provided with competition entry admin rights to create, edit and delete their entry.

Members creating competition entries also have permission to allocate entry admin rights to other members. This allows a user to create an entry on behalf of a team which can then be edited by other team members within the group.

Members creating competition entries may also have permissions to designate other members as having different roles within the competition, for example allowing a member to assess entries according to a rating scale.

The platform application stores a list of [Competition/User] pairs in a database table, called a “join table”. For example, one join table is for admins. Another table is for Judges (being able to use the rating scale). If an entry exists for that user and that competition in the “judges” table, then they are a judge. Admins have the ability to add/delete entries in that join table.

A competition has multiple join tables with respect to users, for example one for admins, one for judges. Further embodiments may include further join tables as required.

Application admins may designate particular groups so that the group's members having non-group manager access to all their network's competitions. Application admins can designate particular members as non-group managers.

An application admin may identify that innovation managers belong to social network application Group X. These innovation managers are then provided with broad access permissions within the platform application. The process here is to save, within the platform application, the identifier of Group X, so that its members can be given the appropriate permissions. It can be changed to Group Y if required later. This group identifier is stored as an attribute of the network object.

In other embodiments, users are specifically identified within the platform application as having particular permissions (stored against the user, rather than against the network).

Table 1 below shows how the platform application uses user permissions during user interaction (some of which can be modified by administrative settings).

TABLE 1

| | | | |
|---|---|---|---|
| 1. Competition | New | ◯ | (External) |
| | | | User.external_admin; |
| | | ◯ | (Internal) |
| | | | User.internal_admin; or |
| | | ◯ | (External) User. |
| | | | group_admins has at least |
| | | | one Group |
| | Create | ◯ | (External) |
| | | | User.external_admin; |
| | | ◯ | (Internal) |
| | | | User.internal_admin; or |
| | | ◯ | (External) |
| | | | Competition.group_id is in |
| | | | the list of |
| | | | User.group_admins |
| | Edit | ◯ | (External) |
| | Update | | User.external_admin; |
| | Delete | ◯ | (Internal) |
| | | | User.internal_admin; |
| | | ◯ | (External) |
| | | | User.group_memberships |
| | | | includes the non-group |
| | | | managers group; |
| | | ◯ | (Internal) |
| | | | User.non_group_manager; or |
| | | ◯ | Both of the following: |

| | |
|---|---|
| ▪ | (External) |
| | Competition.group_id is in |
| | the list of |
| | User.group_memberships; |
| | and |
| ▪ | Either of the following: |

| | |
|---|---|
| ● | (External) |
| | Competition.group_id is |
| | in the list of |
| | User.group_admins; or |
| ● | (Internal) A |
| | Competition_Users record |
| | exists for the |
| | Competition and User. |

| | | | |
|---|---|---|---|
| | List | ◯ | (External) |
| | Show | | User.external_admin; |
| | | ◯ | (Internal) |
| | | | User.internal_admin; |
| | | ◯ | (External) |
| | | | User.group_memberships |
| | | | includes the non-group |
| | | | managers group; |
| | | ◯ | (Internal) |
| | | | User.non_group_manager; or |
| | | ◯ | (External) |
| | | | Competition.group_id is in |
| | | | the list of |
| | | | User.group_memberships |
| 2. Entry | New | ◯ | (External) |
| | Create | | User.external_admin; |
| | | ◯ | (Internal) |
| | | | User.internal_admin; or |
| | | ◯ | (External) |
| | | | Entry.competition.group_id |
| | | | is in the list of |
| | | | User.group_memberships |
| | List | ◯ | (External) |
| | Show | | User.external_admin; |
| | | ◯ | (Internal) |
| | | ◯ | User.internal_admin; |
| | | ◯ | (External) |
| | | | User.group_memberships |
| | | | includes the non-group |
| | | | managers group; |
| | | ◯ | (Internal) |
| | | | User.non_group_manager; or |
| | | ◯ | (External) |
| | | | Entry.competition.group_id |
| | | | is in the list of |
| | | | User.group_memberships |
| | Edit | ◯ | (External) |
| | Update | | User.external_admin; |
| | Delete | ◯ | (Internal) |
| | | | User.internal_admin; |
| | | ◯ | (External ) |
| | | | User.group_memberships |
| | | | includes the non-group |
| | | | managers group; |
| | | ◯ | (Internal) |
| | | | User.non_group_manager; or |
| | | ◯ | Both of the following: |

| | |
|---|---|
| ▪ | (External) |
| | Entry.competition.group_id |
| | is in the list of |
| | User.group_memberships; |
| | and |
| ▪ | Any of the following: |

| | |
|---|---|
| ● | (External) |
| | Entry.competition.group_id |
| | is in the list of |
| | User.group_admins; or |
| ● | (Internal) A |
| | Competition_Users record |
| | exists for the |
| | Entry.competition and |
| | User; or |
| ● | (Internal) A Entry_Users |
| | record exists for the |
| | Entry and User |

Section 1 shows the user options within the platform application for user having different permissions profiles on a competition level. On logging into the platform application a user will be presented with an option to create a competition if they have any of the following permissions: application admin within the social network application; application admin within the platform application; or group admin within any of the social network application groups to which they are a member.

The user will be able to create an object if they have any of the following permissions: application admin within the social network application; application admin within the platform application; or group admin within of the social network application groups for which they are requesting to create a competition. A user is only permitted to create a competition for a group within which they have admin rights—these may be application admin permissions or group admin permissions.

A user can edit, update or delete a competition if they have any of the following permissions: application admin within the social network application; application admin within the platform application; they have acquired competition permission by having created the competition or the user is a group admin in the group for which the competition was created. This confirms that a user can edit, update or delete their own competition and also that group admin permissions allow users to edit, update and delete competitions within that group.

Users are able to see competitions if they have admin permissions in either the social network application or the platform network, they hold non-group manager permissions, or if they are a group member for the group for which the competition was created.

Section 2 shows the user options associated with an entry to a competition within the platform application for a user having different permissions. A user may enter a competition if they hold social network application admin permissions or platform admin permissions or if they are a member of the group for which the competition was created.

A user can edit, update or delete a competition entry if they hold social network application admin permissions or platform application admin permissions; they hold non-group manager permissions; they hold user group admin permissions; they created the competition entry or they have been allocated edit rights to that entry by the creator of the entry.

The specific example of the permissions above illustrates how different users with different permissions can create and interact with competitions and competition entries. These are also illustrated in the role matrix shown in Table 2.

TABLE 2

| | Network | Non-Group | Competition | Group | Entry | Group |
|---|---|---|---|---|---|---|
| | Admin | Manager | Admin | Admin | Admin | Member |
| Competition | | | | | | |
| List/Show | [symbol] | [symbol] | | | | [symbol] |
| New/Create | [symbol] | | | [symbol] | | |
| Edit/Update/Delete | [symbol] | [symbol] | [symbol] | | | |
| Competition_Users | | | | | | |
| List/Show | [symbol] | [symbol] | | | | [symbol] |
| New/Create | [symbol] | | [symbol] | | | |
| Edit/Update/Delete | [symbol] | | [symbol] | | | |
| Entry | | | | | | |
| List/Show | [symbol] | [symbol] | | | | [symbol] |
| New/Create | [symbol] | | | | | [symbol] |
| Edit/Update/Delete | [symbol] | [symbol] | [symbol] | | [symbol] | |
| Entry_Users | | | | | | |
| List/Show | [symbol] | [symbol] | | | | [symbol] |
| New/Create | [symbol] | | | | | [symbol] |
| Edit/Update/Delete | [symbol] | | [symbol] | | [symbol] | |
| Votes | | | | | | |
| List/Show | [symbol] | [symbol] | [symbol] | | [symbol] | [symbol] |
| New/Create | [symbol] | | | | | [symbol] |
| Edit/Update | [symbol] | | [symbol] | | | |
| Delete | [symbol] | | [symbol] | | | |

### Content Creation and Interaction

Once a user has successfully logged into the platform application they are presented with a number of user options for creating and interacting with objects including:
Create competitions;
Edit your competitions;
View your competitions;
Enter competition;
Support/vote for entries;
Rate entries.

Embodiments of the platform application may only display those options available to the user in accordance with the user platform application permissions. The options are now discussed further.

### Creating a Competition

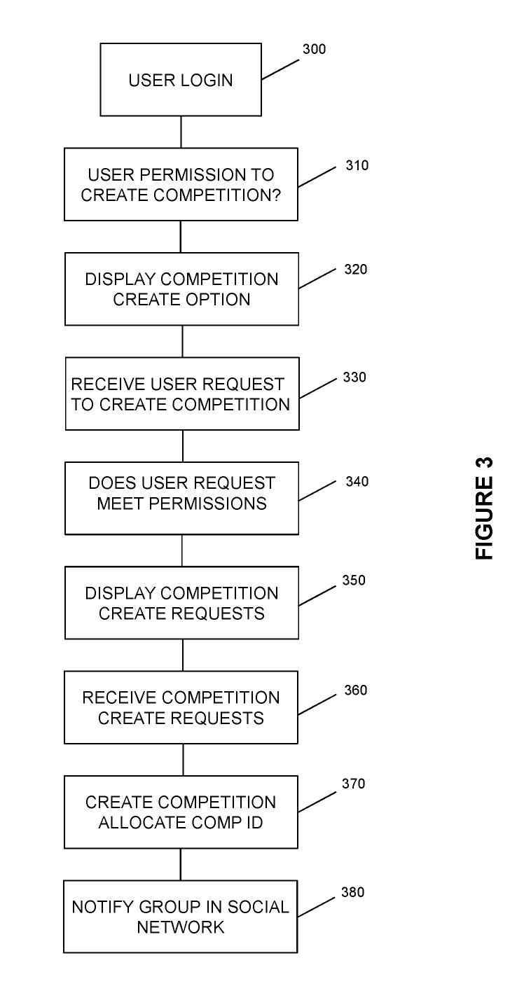

The example discussed now with respect to FIG. 3 and FIG. 4 illustrates how the platform application system implements the permissions structure for a user. At 300 the user logs into the platform application. The user's permissions for the social network application and platform application are retrieved as discussed above.

At 310 the platform application determines whether the user can create a competition by retrieving platform application permissions and network application permissions. This is the first two sub-rows “New/Create” of Competition in Table 1.

Platform application checks whether the user has network application admin permission, platform application admin permission or network application user group admin permissions. If so, the option to create a competition is displayed to the user at 320 on display 520. Using the example of subscriber 1234, since subscriber 1234 has group admin rights for group 7 they are presented with the create competition option.

At 330 the platform application 530 receives a request to create a competition for a user group from user input 525 typically by input from the user. At 340 the platform application confirms whether the user has sufficient permissions to create the competition within the user group. Using the example of subscriber 1234, the user may create competitions for group 7 but not for group 8. The platform application confirms the user has social network admin permissions, platform admin permissions or has user group admin permissions for the selected group.

If the user has sufficient permissions they are displayed a number of fields to provide competition create requests at 350, including:
Competition name;
Description of the competition/rules;
Opening time/closing time for entries;
Opening time/closing time for voting;
Thumbnail image for the competition;
Groups for entry/notification;
Virtual currency allocated to relevant users;
Associated objects within the platform application, for example a list of users who should have administrative rights for the competition object.

“Associated objects” refers to join tables for the competition, as discussed above. This is used for linking many objects of type_1 with many objects of type_2. Each join table is interpreted as implying a particular role/set of permissions.

Typically, the format of the data should be the same across competitions to ensure consistency. Extended functionality can be provided by separate objects which have a competition_id of the relevant competition.

The competition is stored at 370 in platform server 570. The competition is allocated a competition ID at 370.

The platform application determines which members should be notified of the competition using the permissions of the user.

Generally, the notification is limited to the audience that can view the competition on the platform application. So essentially the platform application queries the security database 14 to check which users (or social network application groups) could potentially view it.

Members of group 7 will be notified of the competition via the social network application at 380. Unless they are members of group 7, members of group 8 may not be notified of the competition via the social network application.

Competitions are allocated competition IDs. The competitions are stored along with their competition IDs in the platform application server. In embodiments, the competition IDs are notified to the network application and provided back to the platform application during sign on to associate the competition with the group.

### Notification of Competition to Network Application

In embodiments the platform application sends, on behalf of the user, a notification to the social network that a competition has been created. This may include a link to the platform application which directs the reader to the relevant competition. In embodiments certain information stored in the competition object is included in this notification such as the name and thumbnail image.

The scope of that notification is restricted by the social network, but can be requested by the platform application to be a relevant audience. One example of a relevant audience would be where the recipients, also being subscribers or potential subscribers of the platform application, would be allowed to view the relevant competition.

Generally, the social network application accepts generic notifications.

### Edit/View Competitions

When the user logs into their account they may be presented with a list of competitions which they are able to view in line with the permissions as discussed with respect to Table 1 above. Details of the competition are stored within the platform application database. The subscribed can select any of these competitions for individual review.

For review, the user is presented with a summary of the competition. The user is displayed the entries against the competition and the amount of support each of the entries has been allocated.

The platform application may allow the user to edit some or all of these competitions, either as a result of platform application permissions or social network permissions or a combination of both.

### Competition Entry

When a user logs into their account on the platform application they may be presented with a list of the competitions they are invited to enter. The user can select a competition and create an entry linked to the competition. The entry is linked to the competition. Notification of the entry may be sent to all users via the network application in accordance with the network permissions. As discussed above, a user may allocate other users entry admin permissions to allow them to edit the competition entry.

An entry is linked to a competition and includes:
Entry name
Description
Images
Associated objects within the platform application, for example a competition

### Voting/Support for Entries

When creating a competition, a user may select that group members can vote for entries. In some embodiments a user may allocate a particular number of votes or virtual currency to group members for the competition. Group members may then allocate their currency or votes to the entries in order to show support for the entries. In embodiments, a user creating a competition may be permitted to allocated different number of votes or different level of virtual currency to group members. In embodiments, the visibility of the votes may be restricted during distinct phases of the competition. Votes and virtual currency is stored in a user ‘wallet’ against the user account. Voting and currency allocation may be a permission associated with a user.

Different users may be allocated different permissions for allocating votes or virtual currency to their competitions. For example, some users may be permitted to allocate up to 50 votes, other users may be permitted to allocate up to 100 votes.

The creation of a “vote” has the following effect:
Create a new vote record (attached to the logged in user)
Deducting that amount from the user's wallet
Reducing the number of available rewards (if the vote is eligible to receive a reward)
Notification to the social network application of the user voting for the entry

### Rating Support for Entries

When creating a competition, a user may select that particular group members can rate entries. In some embodiments a user may specify the scale against which the ratings can be made. Group members allowed to rate may then score entries against that scale. In embodiments, competition administrators may be permitted to combine the ratings with other voting systems to determine an overall ranking of entries. In embodiments, the visibility of the ratings and overall rankings may be restricted during distinct phases of the competition. Ratings are stored against the user account. The ability to rate entries may be a permission associated with a user.

Users would typically only be allowed one method of support for entries, either voting or rating.

The creation of a “rating” has the following effect:
Create a new rating record (attached to the logged in user)

Notification to the social network application of the user rating the entry would typically not occur at the time of the rating creation, but may occur later when the overall ranking is announced.

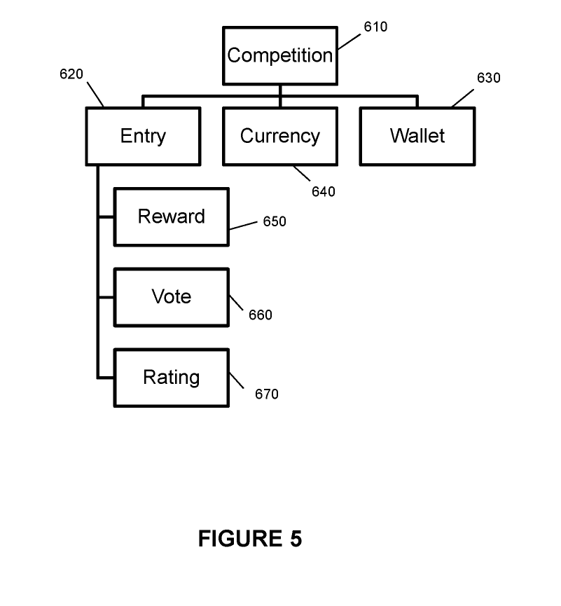

FIG. 5 shows a basic hierarchy of objects in an example of the invention. The basic object is competition 610, which is linked to several entries 620, several wallets 630 (one per group member), and a currency 640 (used for formatting purposes). An entry can have several rewards 650 (available), several votes 660, and several ratings 670.

It will be clear to those skilled in the art that embodiments of the invention provide an application for creating objects for interaction within a social network application. Embodiments manage user permissions and allow permissions to vary between the platform application and the social network application. In embodiments, the platform application is linked to the social network application.

The examples provided above relate to creating competitions and interacting with the competitions within the platform application. It should be understood that the invention is not limited to competitions. Instead, the platform application provides a platform for creation, interaction and management of any user created content.

In each of the examples above each of the objects created, including competition, entry etc has its own access rights which are in some way restricted by a combination of platform application and social network application permissions.

1-4. (canceled)

5. A method according to claim 13 wherein permissions include at least one of:
permission to create a competition;
permission to edit a competition;
permission to create an entry to a competition;
permission to allocate voting chips for a competition;
list of subscribers which the user is permitted to notify.

6. A method according to claim 12 comprising the steps of:
storing the competition object at the first application:
associating entries to the competition to the competition object.

7. A method according to claim 13 comprising the steps of allocating virtual currency to a subscriber, the currency for supporting entries to the competition.

8. A method according to claim 13 wherein the step of allocating virtual currency is made in accordance with at least one permission associated with a user.

9. (canceled)

10. A method according to claim 13 comprising the steps of:
requesting user identification information from the user on receiving the user request to access the first application; and
receiving user identification information;
wherein the step of requesting user access to the network is performed in dependence on the user identification information being authorised by the first application.

11. A method according to claim 13 wherein the content object is a user generated content object.

12. A method according to claim 13 wherein the content object is a competition object.

13. A method for managing content objects, the method performing the steps of:
receiving a user request to access a first application, the application facilitating creation of content objects and notification of the content objects to subscribers within a network;
retrieving first user access rights for the user within the first application, the first user access rights comprising permissions granted to the user within the first application;
requesting user access to the network from a network gateway;
receiving from the network gateway network user access rights of the user, the network user access rights comprising permissions granted to the user within the network;
facilitating creation of a content object by the user;
receiving a user notification request, the user notification request requesting the content object to be notified to network subscribers;
requesting the network to notify the network subscribers of the content object in accordance with the user access rights to the network; and
using the received network user access rights and the retrieved first application user access rights to determine whether to create the content object and notify a subset of the network subscribers of the content object and requesting the network to notify the determined subset of subscribers of the content object in dependence on a result of the determination.

14. A system for managing content objects, comprising:
login engine for receiving a user request to access a first application, the application facilitating creation of content objects and notification of the content objects to subscribers within a network;
means for retrieving first user access rights for the user within the first application, the first user access rights comprising permissions granted to the user within the first application;
means for requesting user access to the network from a network gateway;
means for receiving from the network gateway network user access rights of the user, the network user access rights comprising permissions granted to the user within the network;
facilitating creation of a content object by the user;
input device for receiving a user notification request, the user notification request requesting the content object to be notified to network subscribers;
means for requesting the network to notify the network subscribers of the content object in accordance with the user access rights to the network;
means for using the received network user access rights and the retrieved first application user access rights to determine whether to create the content object and means for requesting notify a subset of the network subscribers of the content object and means for requesting the network to notify the determined subset of subscribers of the content object in dependence on a result of the determination.

15. (canceled)

16. A system according to claim 14 wherein the content object is a competition object or a competition entry object.

17. A system for managing objects, comprising:
user input apparatus, for receiving user input identifying a user request to access a first application, the application facilitating creation of competition objects and notification of the competition objects to a social network;
processor for retrieving a user identification for the user;
processor for automatically generating a request for access rights of the user to the social network and transmitter for transmitting the request to a social network platform for the social network using the user identification;
receiver for receiving from the social network platform user access rights for the social network associated with the user, the user access rights comprising permissions granted to the user within the social network;
processor for creating a competition object in response to the user request;
user input apparatus for receiving user input requesting the competition object to be notified to a target population of subscribers within the social network;
processor for retrieving user access rights for the user within the first application, the first application user access rights comprising permissions granted to the user within the first application;
processor for using the received social network user access rights and the retrieved first application user access rights to determine whether to create the competition object and a subset of the target population to be notified of the competition object; and;
transmitter to request the social network platform to notify the determined subset of subscribers of the competition object in dependence on results of the determination.

18. A system according to claim 17 comprising:
processor for requesting user identification information from the user on receiving the user request to access the first application; and
input apparatus for receiving user identification information;
wherein the step of generating a request for user access rights to the social network and transmitting the request requesting user access to the social network is performed in dependence on the user identification information being authorised by the first application.

19. A system according to claim 17 wherein creation of a competition object comprises creating a competition.

20. A system according to claim 17 wherein creation of a competition object comprises creating an entry to a competition.

21. A system according to claim 17 wherein permissions include at least one of:
permission to create a competition;
permission to edit a competition;
permission to create an entry to a competition;
permission to allocate voting chips for a competition;
list of subscribers which the user is permitted to notify.

22. A system according to claim 17 further comprising:
database for storing the competition object:
processor for associating entries to the competition to the competition object.

23. A system according to claim 17 comprising processor for allocating virtual currency to a subscriber, the currency for supporting entries to the competition.

24. A system according to claim 22 wherein the competition object is stored at a database.
